(19) United States
(12) Patent Application Publication
(10) Pub. No.: US 2002/0003162 A1
(43) Pub. Date: Jan. 10, 2002

(54) Apparatus and method for delivery of targeted marketing to automated service machines

(76) Inventors: John B. Ferber, Baltimore, MD (US); John F. Demayo, Baltimore, MD (US)

Correspondence Address: Finnegan, Henderson, Farabow,, Garrett & Dunner, L.L.P., 1300 I Street, N.W., Washington, DC, 20005-3315, US

(21) Appl. No.: 09/835,377

(22) Filed: Apr. 17, 2001

Related U.S. Application Data
(60) Provisional application No. 60/198,094, filed on Apr. 17, 2000.

(51) Int. Cl. G07G 1/00

(52) U.S. Cl. 235/14

(57) ABSTRACT

Methods and apparatus for advertisements from a processor over a network, such as the Internet to an automated service machine are provided. The automated service machine determines information identifying a user and requests, from the processor, an advertisement based upon the information identifying the user. The processor selects the advertisement based upon the information identifying the user and provides the selected advertisement to the automated service machine. The processor may retrieve information from an advertising database and a consumer profile database to select the advertisement. The automated service machine then presents the selected advertisement to the user.

### CROSS REFERENCE TO RELATED APPLICATIONS

This application claims the benefit of U.S. Provisional Patent Application No. 60/198,094, entitled “APPARATUS AND METHOD FOR DELIVERY OF TARGETED MARKETING TO AUTOMATED SERVICE MACHINES,” filed on Apr. 17, 2000, the disclosure of which is expressly incorporated herein by reference in its entirety.

### DESCRIPTION OF THE INVENTION

1. Field of the Invention

The present invention relates to targeted marketing using automated service machines. In particular, the present invention relates to apparatus and methods for the delivery of targeted advertisements to users of automated service machines, such as automated teller machines (ATMs).

2. Background of the Invention

Recently, multiple use automated service machines, such as ATMs have become common. In addition to dispensing cash, ATMs can now be used for purposes, such as purchasing tickets to sporting and entertainment events, dispensing pre-paid phone cards, dispensing postage stamps, etc. As applications for these machines become broader, more powerful processors, larger displays, and multimedia capabilities are being installed in these machines to accommodate the additional functionality. As a result, these machines now have expanded capabilities and allow for expanded advertising and cross-selling opportunities.

Many ATMs are used to advertise services and products offered by the financial institution that owns the machine. For example, machines such as Cross International's MB2200 ATM machine, allow a financial institution to display color ads about interest rates on loans. Since conventional ATMs cannot target the ads they display, they can only offer ads to the user that are limited in scope and effectiveness.

### SUMMARY OF THE INVENTION

The present invention may improve the effectiveness and scope of ATM-type advertising by providing methods and apparatus for the delivery of targeted marketing to users of automated service machines, such as multiple use ATMs. The present invention may use a wide variety of machines and cards, such as ATM cards, credit cards, and smart cards. The targeted marketing may be based on a plurality of factors including a user's consumer profile. Through the use of targeted marketing, the scope and effectiveness of the advertising presented at these machines may be expanded. In addition, a user may anonymously register to receive targeted marketing.

In accordance with the invention, advertisements from a processor are provided over a network to an automated service machine. The automated service machine determines information identifying a user and requests, from the processor, an advertisement based upon user's identity. The processor selects the advertisement based upon the user's identity and provides the selected advertisement to an automated service machine such as an ATM. The ATM then presents the selected advertisement to the user.

In accordance with another aspect of the present invention, a system for providing advertisements comprises: a first memory for storing information describing a profile of at least one user; a second memory for storing data for a plurality of advertisements; and a processor for selecting at least one of the plurality of advertisements based upon the profile of the user.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate an embodiment of the invention and together with the description, serve to explain the principles of the invention.

### BRIEF DESCRIPTION OF THE DRAWINGS

FIG. 1 illustrates a system for providing targeted marketing consistent with the present invention; and

FIG. 2 illustrates a method for providing targeted marketing consistent with the present invention.

### DETAILED DESCRIPTION

Reference will now be made in detail to an embodiment of the invention, an example of which is illustrated in the accompanying drawings. Wherever possible, the same reference numbers will be used throughout the drawings to refer to the same or like parts.

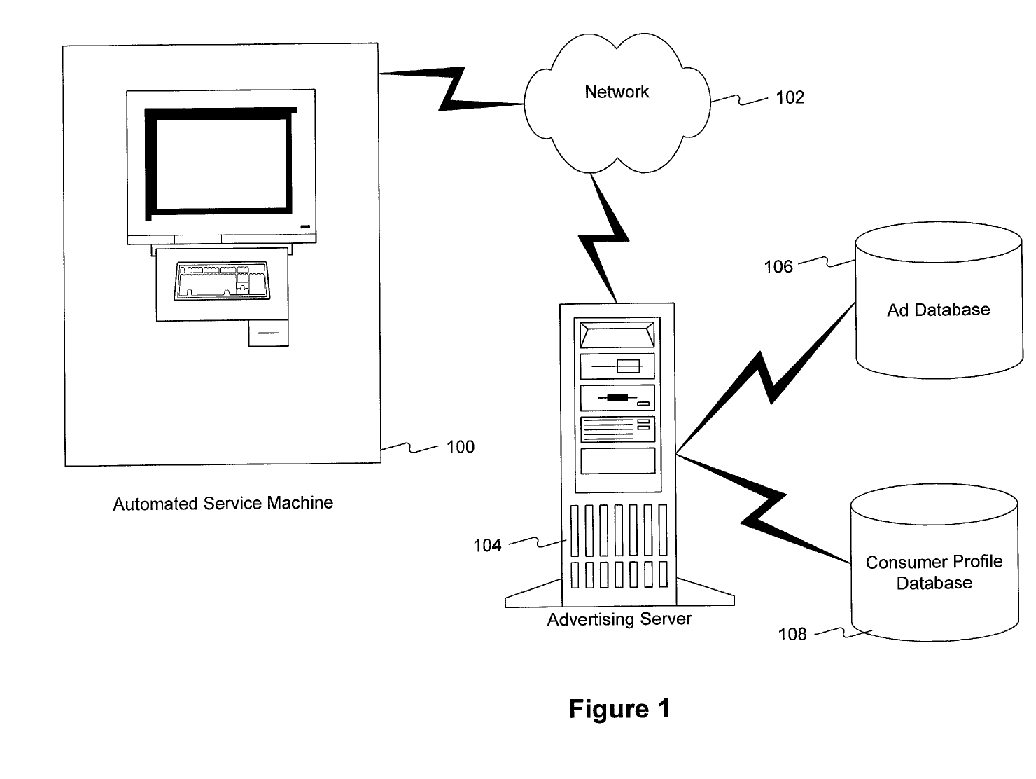

FIG. 1 illustrates a system for providing targeted marketing consistent with the present invention. In particular, FIG. 1 shows: an automated service machine 100, a network 102, an advertising server 104, an advertising database 106 and a consumer profile database 108. The automated service machine 100 allows a user to obtain items such as cash, tickets to sporting and entertainment events, pre-paid phone cards, postage stamps, etc.

For example, the automated service machine 100 may be a multiple use ATM. The automated service machine 100 may have a display, such as a color CRT or LCD flat-panel display, and an audio output such as a speaker. The automated service machine may also have an account access card reader, a keypad, a printer, and a dispenser. The automated service machine 100 may include a processor, a memory, and a communication interface, such as a modem or wireless modem.

The automated service machine 102 is connected, e.g., via a communication link to the network 102. In one embodiment, the network 102 may provide communications between the automated service machine and the advertising server 104. The network 102 may be implemented in a wide variety of ways. For example, the network 102 may be implemented as a private network, such as an X.25 network or frame relay network. Alternatively, the network 102 may be a public network such as the Internet. In addition, the network 102 may be implemented by a combination of wireline and wireless technologies. Communications over the network 102 between the automated service machine 100 and the advertising server 104 may be protected using security technologies, such as encryption. However, security technologies may not be used where security is not a concern.

In one embodiment, the advertising server 104 may determine one or more advertisements to provide to the user via the automated service machine 100. The advertising server 104 may be also implemented as dedicated hardware or as software integrated within another device, e.g., a web server. For example, the advertising server 104 may be implemented within a website connect to the Internet. Alternatively, the advertising server 104 may be connected to the network 102 via an Internet access device or firewall (not shown). The advertising server 104 may use the advertising database 106 and the consumer profile database 108 to determine the one or more advertisements targeted to the user. The advertising database 106 may store information for targeted advertisements. For example, the targeting database 106 may store targeted advertisements, such as audio-based advertisements, visual-based advertisements, multi-media advertisements, electronic coupons, paper-based advertisements, paper-based coupons, or any combination thereof. The consumer profile database 108 may store information describing the user and his/her interests. For example, the consumer profile database 108 may include information such as name, address, and phone number, sex, age and subject areas of interest. The consumer profile database 108 may further include information describing the behavior of the user, such as recent withdrawals, purchases, and coupons redeemed. The consumer profile database 108 may also store information from third parties. For example, the consumer profile database 108 may include information from the user's bank, the user's credit card company, or third party marketing firms.

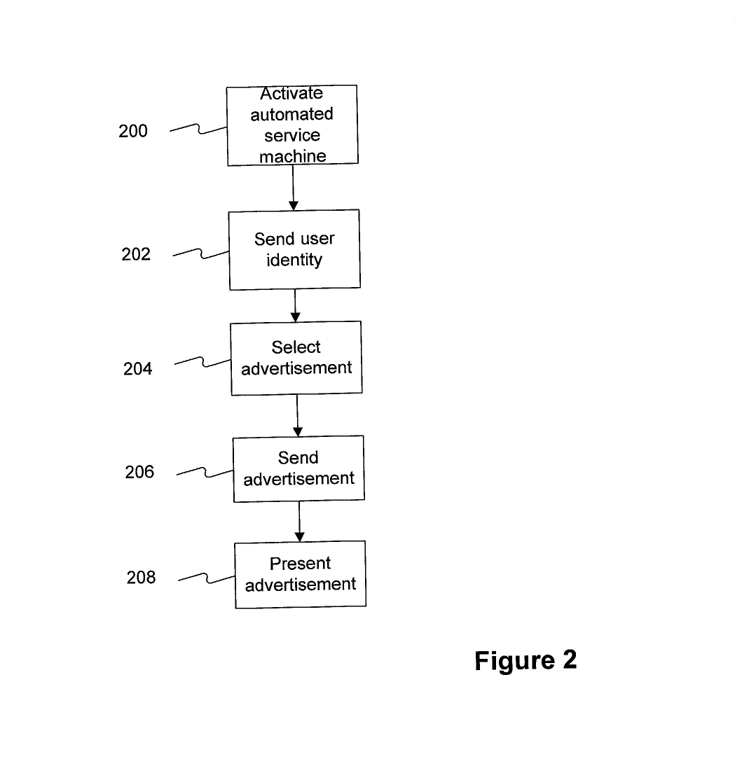

FIG. 2 illustrates a method for providing targeted marketing consistent with the present invention. First, a user may activate the automated service machine 100 (step 200). For example, the user may insert a card, such as an ATM card or smart card into the card reader and enter a personal identification number via the keyboard. The automated service machine 100 may authenticate the user's identity, e.g., based upon the entered personal identification number and data read from the access card or smart card.

Alternatively, the user may register as a new consumer and have an identifier code recorded on their card. For example, the user may provide answers to questions concerning their address, sex, age, work, and subject areas of interest. The identifier code then allows the user to receive offers anonymously. The automated service machine may also display or offer incentives to encourage registration.

Once activated, the automated service machine 100 may transmit information regarding the identity of the user to the advertising server 104 via the network 102 (Step 202). For example, the automated service machine 100 may send the user's name and account number. The automated service machine 100 may also send the user's identifier code recorded on the user's access card. In addition, the automated service machine 100 may transmit information describing its current conditions and characteristics such as local time, location information, display type, printer type, etc. Alternatively, the automated service machine 100 may send information stored on the user's smart card, such as the user's identity and consumer profile.

Upon receiving the information regarding the identity of the user, the advertising server 104 may select a targeted advertisement. The advertising server 104 may retrieve the user's consumer profile in the consumer profile database 108. Based on the retrieved consumer profile, the advertising server 104 may then select the targeted advertisement from the advertising database 106. For example, the advertising server 104 may select an advertisement for a clothing store based upon the user's sex.

The advertising server 104 may also select the targeted advertisement based upon other factors, such as the history of the user's consumer profile. In addition, the advertising server 104 may select the targeted advertisement based upon characteristics and/or conditions at the automated service machine 100 such as, current time, location of the automated service machine 100, printer type, display type, etc. For example, the advertising server 104 may select advertisements to match the display resolution and/or printer characteristics of the automated service machine being accessed. Advertising server 104 may alternatively select advertisements based on the time of day or the day of the month, etc. For example, the advertising server 104 may select an advertisement for a restaurant if the local time at the automated service machine 100 is around lunchtime or if the restaurant is located nearby. Also, the advertising server 104 may select an advertisement related to a holiday, such as an advertisement for discounted Thanksgiving turkeys in November. Therefore, by evaluating information from the automated service machine and information regarding the identity of the user, the advertising server 104 may select a targeted advertisement.

After selecting the targeted advertisement, the advertising server may then transmit the targeted advertisement to the automated service machine 100 (Step 206). The automated service machine 100 may then present the targeted advertisement to the user (Step 208). For example, the automated service machine 100 may display the targeted advertisement and/or play audio through the speakers. In addition, the automated service machine may print the targeted advertisement using the printer.

In addition, the automated service machine may present electronic advertisements from the advertising server 104, such as electronic coupons. For example, the automated service machine 100 may deliver an electronic coupon to the smart card of the user. These electronic coupons may be associated with the identifier code and tracked in order to update the user's consumer profile.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of providing advertisements from a processor to an automated service machine over a network, comprising:
determining, at the automated service machine, information identifying a user;
requesting, from the processor, an advertisement based upon the information identifying the user;
selecting, at the processor, the advertisement based upon the information identifying the user;
providing the selected advertisement to the automated service machine; and
presenting the selected advertisement.

2. The method of claim 1, wherein the step of selecting advertisement based upon the information identifying the user comprises the steps of:
determining a profile of the user based upon the user;
determining information describing the automated service machine; and
selecting the advertisement based on the profile of the user and the automated service machine.

3. The method of claim 2, wherein the step of determining information describing the automated service machine comprises the steps of:
determining a location of the automated service machine.

4. The method of claim 2, wherein the step of determining information describing the automated service machine comprises the steps of:
determining a display resolution of the automated service machine.

5. The method of claim 2, wherein the step of determining information describing the automated service machine comprises the steps of:
determining a printer of the automated service machine.

6. The method of claim 2, wherein the step of determining information describing the automated service machine comprises the steps of:
determining a local time for the automated service machine.

7. A system for providing advertisements, comprising:
a first memory for storing information describing a profile of at least one user;
a second memory for storing data for a plurality of advertisements;
a processor for selecting at least one of the plurality of advertisements based upon the profile of the at least one user;
a network coupled to the processor; and
an automated service machine, coupled to the network, for providing information identifying the at least one user and presenting the at least one advertisement selected by the processor.

8. An automated service machine, comprising:
at least one user interface for receiving information identifying a user;
a communications interface for requesting an advertisement based upon the information identifying the user; and
at least one output interface for presenting the advertisement based upon the information identifying the user.

9. The automated service machine of claim 8, wherein the at least one user interface comprises a keyboard.

10. The automated service machine of claim 9, wherein the at least one user interface comprises a card reader.

11. The automated service machine of claim 9, wherein the communications interface comprises a modem.

12. The automated service machine of claim 9, wherein the at least one output interface comprises a display.

13. The automated service machine of claim 9, wherein the at least one output interface comprises a printer.

14. An apparatus for providing advertisements from a processor to an automated service machine over a network, comprising:
means for determining, at the automated service machine, information identifying a user;
means for requesting, from the processor, an advertisement based upon the information identifying the user;
means for selecting, at the processor, the advertisement based upon the information identifying the user;
means for providing the selected advertisement to the automated service machine; and
means for presenting, at the automated service machine, the selected advertisement.
